(19) United States
(12) Patent Application Publication
(10) Pub. No.: US 2004/0066728 A1
(43) Pub. Date: Apr. 8, 2004

(54) Data storage

(76) Inventors: Min Gu, Victoria (AU); Dennis McPhail, Victoria (AU)

Correspondence Address: Mark G Lappin, McDermott Will & Emery, 28 State Street, Boston, MA, 02109, US

(21) Appl. No.: 10/433,930

(22) PCT Filed: Dec. 7, 2001
(86) PCT No.: PCT/AU01/01585

(30) Foreign Application Priority Data
Dec. 8, 2000 (AU) PR 1974

(51) Int. Cl. G11B 7/00

(52) U.S. Cl. 369/103

(57) ABSTRACT

The invention relates to materials and devices including these materials which have three-dimensional optical data storage capabilities, as well as to related methods and apparatus for storage, reading and erasing optical data. In particular, the invention relates to a three-dimensional optical data storage device comprising a data storage material which comprises a polymer matrix and nematic liquid crystal droplets wherein the nematic liquid crystal droplets are dispersed through the polymer matrix. The invention also relates to a method of storing optical data comprising exposing zones of data storage material to coherent polarised infra-red light at a wavelength and power sufficient to cause alignment of directors of illuminated zones of nematic liquid crystal droplets with in the data storage material, as well as to a method of reading optical data from a three-dimensional optical data storage device which comprises exposing data storage material which has optical data stored therein to coherent polarised infra-red light at a wavelength and power sufficient to cause zones of aligned directors of nematic liquid crystal droplets within the material to fluoresce at a detectably greater intensity compared to zones of non-aligned directors and detecting fluorescence within the zones of aligned directors.

### FIELD OF THE INVENTION

The present invention relates to materials and devices including these materials which have three-dimensional optical data storage capabilities, as well as to related methods and apparatus for storage, reading and erasing optical data.

### BACKGROUND OF THE INVENTION

The corporate and technology sectors of today have a high reliance on information technology (IT) systems. These IT systems place great demands on the capacity of current data storage devices. As such, an immense amount of research has been conducted in the field of three-dimensional optical data storage. Three-dimensional (3-D) optical data storage systems can achieve data densities in the order of 100 to 1000 times greater than conventional two-dimensional (2-D) data storage systems such as compact discs (CD) and digital versatile discs (DVD).

The materials used for current research on 3-D optical data storage systems can be divided into three broad categories; these being photorefractive crystals¹ (such as LiNbO₃), various types of glasses², and polymer based materials.

Known polymer based materials for use in 3-D optical data storage can be separated into photobleaching, photochromic and photorefractive types. Photobleaching materials can achieve high data densities but are not erasable (or re-writable). Photochromic materials^{3,4}, which rely on trans-cis isomerisation have the ability to be erased and re-written but demonstrate a relatively short data lifetime. Photorefractive materials^{5,6} which rely on spatial modulation of the refractive index within the region of the focal spot are also erasable and rewritable and provide high resolution. Because of the localised change in refractive index demonstrated by these photoreactive materials, which can be erased via illumination with Ultraviolet (UV) light, they have been contemplated for use in optical data storage.

One drawback of these types of photorefractive polymers is the high electric field that needs to be applied to cause the desired photorefractive effect⁷. Another way to induce molecular reorientation with an electric field involves the use of materials with dielectric anisotropy, such as liquid crystals. It is possible to combine the high resolution of photorefractive polymers and the high refractive index change associated with liquid crystals by utilising polymer dispersed liquid crystals (PDLCs), in the context of optical data storage⁷.

PDLCs consist of small micro-droplets of liquid crystals dispersed in a polymer matrix. These materials are erasable and re-writable and provides a large refractive index change⁷ (Δn=2×10⁻³). The electric field of the focussed illumination (writing) light induces by two-photon excitation the re-orientation of the director of the nematic liquid crystals within the droplets. In the unexposed zone, the liquid crystal directors have random alignment, but in the exposed zone the directors align. The response to an applied field depends upon the sign of the dielectric anisotropy of the liquid crystal. For example, in the case where the dielectric anisotropy is positive, the directors align with the electric field of the illumination light. This produces a photorefractive effect similar to that of other photorefractive polymers.

It has surprisingly been found by the present inventors that PDLC materials demonstrate a field induced polarisation effect such that the characteristics of the fluorescence change depend upon whether the liquid crystal directors are aligned with the polarisation state of the reading beam. In aligned zones, the fluorescence varies with the polarisation state of the reading illumination light. In contrast, in the non-aligned region (where there is random director alignment) no such polarisation dependency is shown. This effect becomes useful when utilised for bit data storage. The written zone (aligned directors) fluoresces more intensely than the unwritten zone, which provides a mechanism for reading the stored data. Polarisation dependency also allows polarisation multiplexing of data bits. If the polarisation state of the writing beam is varied, another dimension can be added to the ability of the material to store data. This allows additional information to be encoded into each data bit so that instead of just 1 and 0, the logic states can be 0, 1, 2 . . . , depending upon the alignment of the polarisation state of the reading beam.

### SUMMARY OF THE INVENTION

According to one embodiment of the invention there is provided a three-dimensional optical data storage device comprising a data storage material which comprises the following components:

(a) a polymer matrix; and

(b) nematic liquid crystal droplets;

wherein component (b) is dispersed through the polymer matrix.

According to another embodiment of the present invention there is provided a method of storing optical data comprising exposing zones of data storage material of a three-dimensional optical data storage device to coherent polarised light at a wavelength and power sufficient to cause alignment of directors of illuminated zones of nematic liquid crystal droplets within the data storage material; wherein the light encodes for the data to be stored, and wherein the data storage material comprises the following components:

(a) a polymer matrix; and

(b) nematic liquid crystal droplets;

wherein component (b) is dispersed through the polymer matrix.

According to a further embodiment of the invention there is provided a method of reading optical data from a three-dimensional optical data storage device which comprises exposing data storage material of the device which has optical data stored therein to coherent polarised light at a wavelength and power sufficient to cause zones of aligned directors of nematic liquid crystal droplets within the data storage material to fluoresce at a detectably greater intensity compared to zones of non-aligned directors and detecting fluorescence within the zones of aligned directors; wherein the data storage material comprises the following components:

(a) a polymer matrix; and

(b) nematic liquid crystal droplets;

wherein component (b) is dispersed through the polymer matrix.

According to a further embodiment of the present invention there is provided a method of erasing bulk optical data stored on a three-dimensional optical data storage device which comprises exposing data storage material of the device to incoherent unpolarised ultraviolet light; wherein the data storage material comprises the following components:

(a) a polymer matrix; and

(b) nematic liquid crystal droplets;

wherein component (b) is dispersed through the polymer matrix.

According to another aspect of the invention there is provided a method for erasing bit optical data stored on a three-dimensional optical data storage device and for overwriting with new data which comprises exposing a zone where the bit data is stored within the data storage material to coherent polarised light rotated by between about 30° to about 150° relative to direction of coherent polarised light used to store the data, which rotated light is at a wavelength and power sufficient to realign directors of illuminated zones of nematic liquid crystal droplets in illuminated zone within the data storage material; wherein the rotated light erases the previously written data, and wherein the data storage material comprises the following components:

(a) polymer matrix; and

(b) nematic liquid crystal droplets;

wherein component (b) is dispersed through the polymer matrix.

According to a still further embodiment of the present invention there is provided apparatus for storing optical data to, and reading optical data from, a data storage device, which apparatus comprises:

(i) means for retaining and locating the device;

(ii) a source of coherent polarised light at a wavelength and power sufficient to cause alignment of directors of illuminated zones of nematic liquid crystal droplets within data storage material of the device;

(iii) a source of coherent polarised light at a wavelength and power sufficient to cause zones of aligned directors of nematic liquid crystal droplets to fluoresce at a detectably greater intensity compared to zones of non-aligned directors within the data storage material;

(iv) means for detecting fluorescence within the zones of aligned directors.

In a preferred embodiment of the invention the three-dimensional optical data storage device further comprises a photosensitive material dispersed through the polymer matrix.

In a preferred embodiment of the invention the three-dimensional optical data storage device further comprises a plasticiser dispersed through the polymer matrix.

In another preferred embodiment of the invention the data storage material comprises an initiator.

Preferably the data storage material comprises between about 10 to about 70 weight percent of polymer matrix, between about 20 to about 90 weight percent of nematic liquid crystal droplets and up to about 5 weight percent of photosensitive material and optionally up to about 0.1 weight percent of initiator and up to about 40 weight percent of plasticiser.

Preferably the data storage material is between about 10 μm and to about 2,000 μm in thickness.

In a preferred embodiment of the invention the polymer matrix is poly(methyl methacrylate) (PMMA), poly (vinyl chloride) (PVC), poly (vinyl carbazole) (PVK) or poly (vinyl alcohol) (PVA).

In another preferred embodiment of the invention the nematic liquid crystal droplets are selected from E 49, E 44 and E 7, each available from Merck Pty Ltd.

In another preferred embodiment of the invention the photosensitive material is selected from 2,4,7-trinitro-9-fluorenone (TNF) or other fluorenones such as C₆₀, also known as buckminsterfullerene (buckyball).

In another preferred embodiment of the invention the plasticiser is selected from N-ethylcarbazole, iso-butyl formate and methyl isobutyrate.

In a further preferred embodiment of the invention the initiator is benzoyl peroxide.

In a further embodiment of the invention the optical data storage device is used only for data storage in two dimensions.

In another embodiment of the invention the device comprises a substrate, on or about which the data storage material is located.

In another embodiment of the invention the substrate protectively encloses the data storage material and at least a region of the substrate allows transmission of ultraviolet, visible and infra-red radiation to and from the data storage material Preferably the apparatus referred to above also includes a UV light source.

Preferably, in the apparatus referred to above the means for retaining and locating the device is adapted to controllably move the device in three dimensions.

### BRIEF DESCRIPTION OF THE FIGURES

FIG. 1(a) shows an image of PDLC material when illuminated at a wavelength of 850 nm under two-photon excitation. The white dots show regions where the liquid crystal directors are aligned due to previous illumination and the darker region that was not previously illuminated.

FIG. 1(b) graphically depicts alignment of the liquid crystal directors which is responsible for the effect shown in FIG. 1(a).

FIG. 2 shows chemical structures in respect of various components of a PDLC material wherein FIG. 2(a) depicts poly(methyl methacrylate) (PMMA), FIG. 2(b) depicts 2,4,7-trinitro-9-fluorenone (TNF), FIG. 2(c) depicts N-ethylcarbazole (ECZ) and FIG. 2(d) depicts 4-pentyl 4-cyano biphenyl (E49).

FIG. 3 shows a plot of absorption (in arbitrary units) against wavelength (nm) for a sample of PDLC material which includes the components PMMA:E49:ECZ:TNF in the ratio 45:33:21: 1, by weight percentage.

FIG. 4 shows a diagrammatical representation of an experimental apparatus equipped to store and read optical data from data storage material according to the invention.

FIG. 5 is a plot of fluorescence intensity (arbitrary units) against polarisation angle (degrees) of the reading beam for regions of a PDLC sample containing the components PMMA:E49:ECZ:TNF in the ratio 45:33:21:1, by weight percentage. The polarisation angle is the angle between the polarisation direction of the writing and reading laser beams. There is no variation in fluorescence intensity with variation of the reading beam for the regions of the material to which data has not been stored; the fluorescence in these regions is zero arbitrary units.

FIG. 6 shows fluorescence intensity of the aligned liquid crystal directors as a function of writing power, in two cases. The writing illumination was at a wavelength of 900 nm and various powers as shown on the plot. The reading illumination was also conducted at a wavelength of 900 nm with power of 30 mW. In both cases the objective was ULWD MSPlan 100-IR NA 0.80. In the first case the data bits were read at a 0° polarisation shift from the writing beam and in the second case the data bits were read at a 90° polarisation shift from the writing beam.

FIG. 7 shows fluorescence following reading illumination at a wavelength of 900 nm and a power of 30 mW (objective ULWD MSPlan 100-IR NA 0.80) after three different layers of data storage material have been exposed to writing illumination at a wavelength of 900 nm and power of 60 mW for 60 ms (objective ULWD MSPlan 100-IR NA 0.80). The layer shown in FIG. 7(a) (the letter C) is near the surface of the PDLC material and the layer shown in FIG. 7(b) (the letter M) is at a 2 μm depth into the polymer. The layer shown in FIG. 7(c) (the letter P) is at a depth of 4 μm into the polymer. Each image is of a 24×24 block of data with 1.56 μm point spacing.

FIG. 8 shows fluorescence following reading illumination at a wavelength of 900 nm and a power of 40 mW (objective ULWD MSPlan 100-IR NA 0.80). FIG. 8(a) (the letter B) shows a 24×24 block of data with point spacing of 2.9 μm after exposure to writing illumination at a wavelength of 900 nm and power of 60 mW for 80 ms (objective ULWD MSPlan 100-IR NA 0.80). The layer shown in FIG. 8(b) is the same layer as shown in FIG. 8(a), but after erasure of data by exposure to UV light from a mercury lamp, which redistributes directors of liquid crystals. The layer shown in FIG. 8(c) (the letter C) shows data rewritten after erasure in the same layer, using the same conditions adopted in FIG. 8(a). The circles in the images show defects in the polymer, confirming the images are taken of the same layer of polymer material and at the same depth.

FIG. 9 shows images which demonstrate the erasure of individual data bits. In this figure the writing illumination was at a wavelength of 900 nm and power of 60 mW with exposure time of 80 ms and the reading illumination was also at a wavelength of 900 mn but at a power of 30 mW. In both cases the objective was a ULWD NSPlan 100-IR NA 0.80. In FIG. 9(a) the letter “L” was written into the polymer material using a polarisation shift of the writing beam of 0°. The area of interest was then read at 90° showing the fluorescing data bits of the letter “L”. In FIG. 9(b) an image is shown of fluorescence from the reading beam after individual bits within the polymer material have been exposed to further writing illumination wherein the polarisation angle is rotated by 90°, and which was at a high power (60-80 mW). This has the effect of reducing the relative fluorescence of the individual bit concerned when read at 90° polarisation shift under low power (30 mW).

FIG. 10(a) shows fluorescence (reading) with illumination at 850 nm and 40 mW (objective ULWD MSPlan 100-IR NA 0.80) after storage illumination (writing) at 900 nm and 50 mW for 50 ms (objective ULWD MSPlan 100-IR NA 0.80), after the material has been exposed to reading 300 times. FIG. 10(b) shows the same material after it has been exposed to reading another 500 times.

FIG. 11 shows a plot of fluorescence intensity (arbitrary units) against excitation wavelength for PDLC material comprising the components PMMA:E49:ECZ:TMF in the ratios 45:33:21:1, by weight percentage, following writing illumination at 900 nm and 40 mW for 50 ms (objective ULWD MSPlan 100-IR NA 0.80) and using reading illumination at 10 mW and varied wavelength, with polarisation angle of 90° (objective ULWD MSPlan 100-IR NA 0.80).

FIG. 12 shows a plot of the log of fluorescence intensity as measured in arbitrary units against the log of input power as measured in mW, to obtain a plot of quadratic dependence of 2-photon (2-p) excitation within stored data bits of the polymer material. The plot shows a slope of 1.98, which is indicative of 2-photon excitation. The drop off at the upper end of the plot demonstrates the onset of saturation.

FIG. 13 shows plots of fluorescence intensity in arbitrary units against fluorescence at 0 (a), 30 (b), 60 (c) and 90 (d) degrees polarisation of the reading beam angle relative to the writing illumination. These plots show how the peak of fluorescence can be shifted throughout the 90° reading beam rotation. This characteristic can be used to achieve more than simple binary data storage. In this case, four data values can be stored at each bit data point.

### DETAILED DESCRIPTION OF THE INVENTION

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that that prior art forms part of the common general knowledge in Australia.

The disclosures of all references referred to within this specification are included herein in their entirety, by way of reference.

In its broadest aspect the present invention relates to a three-dimensional optical data storage device. By the language “three-dimensional” it is intended to mean that the data storage material contained therein or which itself constitutes the device has the ability to store optical data in three dimensions through its volume. Naturally, devices of the invention may also be adapted for two-dimensional data storage, although this is not preferred. The data which may be stored on the devices of the invention may for example be binary digit or bit data that is converted from an electronic signal to an optical signal for storage. The read optical signal may then be converted back to an electronic signal. Processes for conversion of electronic signals to optical signals and visa versa are well recognised in the art.

In one aspect of the invention the device constitutes simply the data storage material itself which takes the form of a polymer dispersed liquid crystal (PDLC). In other embodiments of the invention however the three-dimensional optical data storage device may include a substrate onto which or about which the PDLC is located. For example the substrate may be glass, ceramic, plastics or other suitable, preferably inert material. Preferably the substrate will take the form of a protective coating surrounding or containing the PDLC data storage material. It is also preferred that at least a region of the substrate, in the case where it does surround or contain the data storage material, allows the transmission of electromagnetic radiation and in particular ultraviolet, visible and infra-red light. It may be the case that the data storage device of the invention takes the form of a card or disc which may conveniently be inserted into information technology equipment, such as computers, computer operated devices, hi-fi equipment, video equipment or the like. In such devices a transparent window may be provided within the cover through which data can be stored (written) or retrieved (read) to or from the device. For example, the devices of the invention may take the shape or configuration of conventional computer disks, CDs or DVDs. These possibilities are mentioned by way of example only and are not intended to be limiting upon the scope of the invention.

The key feature of the data storage devices according to the invention is the data storage material itself, which constitutes a PDLC material including at the very least a polymer matrix and nematic liquid crystal droplets. Preferably the data storage material will also include a photosensitive material. The polymer matrix may be comprised of any polymer material characterised by low electromagnetic absorption in the wavelength range of 300 nm to 1080 nm, and which has suitable physical properties such as the ability to be formed in appropriate configuration and satisfactory strength, as well as suitable durability, stability, etc. Examples of suitable polymer matrices include poly (methyl methacrylate) (PMMA), poly (vinyl chloride) (PVC), poly (vinyl carbazole)(PVK) or poly (vinyl alcohol) (PVA). Preferably, the data storage material will include between about 10 and about 70 weight percent of polymer matrix. A preferred polymer matrix is PMMA.

The nematic liquid crystal droplets utilised in the invention will, as a result of the synthetic approach adopted in formation of the data storage material, be dispersed through the polymer matrix. The liquid crystals within the droplets demonstrate dielectric anisotropy so that the director of the liquid crystal is reoriented upon exposure to an electric field resulting from polarised and coherent illumination with electromagnetic radiation, preferably infra-red radiation. By the term “coherent” it is intended to convey that the radiation is in phase. Some examples of suitable nematic liquid crystal materials include E 49, E 44 and E 7 type nematic liquid crystals available commercially from Merck Pty Ltd. Preferably the liquid crystal will be present within the data storage material in amounts between about 20 and about 90 weight percent.

Although not essential, it is preferred that the data storage material should include a photosensitive material that absorbs radiation in the ultra-violet to visible region of the electromagnetic spectrum. Some examples of suitable photosensitive materials include fullerenes such as C₆₀ (also known as buckminsterfullerene or buckyball, the structure of which is shown below, and in particular 2,4,7-trinitro-9-fluorenone (TNF).

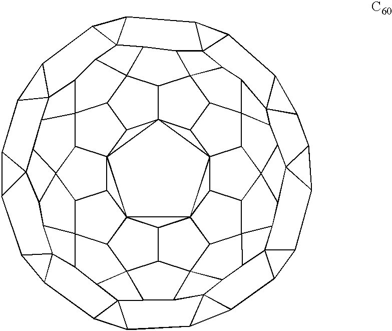

It is also preferred that the data storage material will include a plasticiser which is compatible with the polymer matrix concerned. Appropriate plasticisers are well known in the art, but in relation to use with PMMA examples of suitable plasticisers include N-ethylcarbazole, iso-butyl formate and methyl isobutyrate. The plasticiser may for example be present within the data storage material in an amount of up to about 40 weight percent. The plasticiser will tend to reduce the glass transition temperature of the data storage material.

It is also preferable that an initiator, such as for example benzoyl peroxide is included within the data storage material. Other initiators which can be utilised are well known in the art. The data storage material according to the invention may additionally include other components routinely used in the polymer chemistry field.

It is possible to store optical data to the data storage material by exposing the material to polarised light at a wavelength and power sufficient to cause alignment of directors of illuminated zones of the nematic liquid crystal droplets within the data storage material. For example the incident light may be coherent polarised light focused onto a particular zone of the data storage material with sufficient photon density to allow two-photon absorption. Wavelengths in the range of 500 to 1080 nm may be used for this two-photon excitation process, which will also be referred to throughout as data storage or writing. Optical power of between about 2 mW up to about 180 mW may be adopted in this data storage process. Preferably the wavelength of the writing illumination will be between about 800 and about 1000 nm, more particularly preferably-between about 850 and 950 nm, particularly preferably in the order of 900 nm. Preferably the optical power utilised in the writing illumination is between about 30 to about 100 mW, more preferably between about 40 to about 80 mW, particularly preferably in the order of about 50 or 60 mW. An objective lens (for example ULWD MSPlan 100-IR NA 0.80) may be utilised to focus the illumination to the desired zones of the data storage material. Objective lenses such as that referred to above are commercially available from Olympus and Carl Zeiss, Inc. Preferably the illumination will be provided by an ultrashort pulsed laser (for example a Spectra-physics Tsunami (TI-sapphire) femtosecond pulsed laser). Pulse widths of between about 5 to about 500 fs, preferably between about 20 and 200 fs, particularly preferably between about 60 and 100 fs and most particularly in the order of about 80 fs may be utilised, with a repetition rate of between about 10 to about 200 MHz, preferably between about 40 to about 100 MHz, particularly preferably between about 70 to 90 MHz, most preferably about 82 MHz. Continuous wave (CW) two-photon illumination may also be utilised.

To read data already stored to the data storage material the data storage material with optical data stored therein will be exposed to light at a wavelength and power sufficient to cause zones of aligned directors of nematic liquid crystal droplets within the data storage material to fluoresce at a detectably greater intensity compared to zones of non-aligned directors. The conditions utilised for the reading illumination are similar to those outlined above in relation to the writing or storage illumination, with the exception that it is most preferable for the reading illumination to be conducted at slightly lower power, for example at power of between about 10 to 100 mW, preferably between about 20 to 60 mW, particularly preferably at about 30 mW. Following the reading illumination it is necessary to detect the fluorescence within the zones of aligned directors. This detection may for example be achieved utilising a fluorescence detection system, such as for example a photomultiplier tube (PMT) or CCD camera. CCD cameras can be purchased readily from many companies such as Apogee Instruments Inc., PULNiX, Polaroid and JVC. The fluorescence may also be detected with the use of a photodiode or a split photodiode detector. These devices convert the fluorescence light into electrical signals for the detection circuitry.

It is possible to erase bulk data stored on the data storage material by exposure of the data storage material to incoherent, unpolarised light within the wavelength range of 300 nm to 1080 nm. What is meant by “bulk” erasure is that data is erased indiscriminately from all regions of the data storage material exposed to the erasing light source. Preferably, the light utilised for erasing data stored on the data storage material is ultraviolet light, which may for example be generated by a mercury lamp. Ultraviolet (UV) light of this type redistributes the directors of the liquid crystals within the droplets thereby effectively resulting in deletion of the stored data. It is additionally possible to effect erasure of stored data using circularly polarised coherent light, and in this manner it is possible to effect partial erasure of the data storage material, that is, erasure of selected zones of the material.

It is also possible to erase bit data. That is, to erase stored data in a more discriminating fashion than the bulk erasure, and from specific zones where data has been stored. This erasure is achieved by overwriting the bit data stored with a new data signal. In practice this is carried out by rotating the writing illumination beam by between about 30 degrees to about 150 degrees relative to the angle of polarisation of the writing beam which stored the original data bit. Preferably the polarisation rotation angle will be approximately 90 degrees relative to the angle of polarisation of the original writing illumination. The illumination used to overwrite stored bit data will preferably be at power of between about 50 mW to about 100 mWw, preferably between about 60 to about 80 mW. The result will be that when this overwritten bit is read at low power by reading illumination at 90 degrees, its relative fluorescence will be reduced compared to other bits of data written under the same conditions as the original bit.

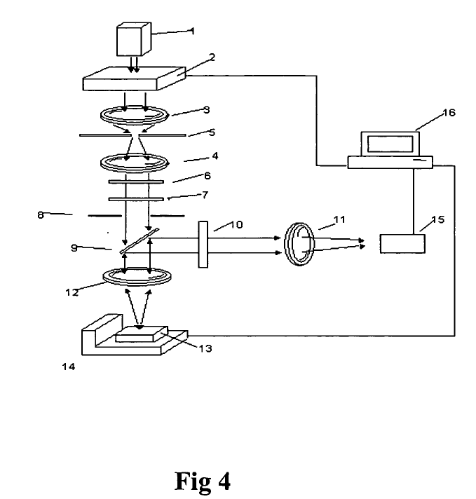

The invention also includes apparatus that can be utilised to store data to the data storage material, read data from the data storage material and optionally erase data stored on the data storage material. A schematic example of such apparatus is shown in FIG. 4 and is further discussed in example 3 below. In a particularly preferred embodiment of the invention the apparatus includes at least means for retaining and locating the data storage device, a source of coherent light at a wavelength and power sufficient to cause alignment of directors of illuminated zones of nematic liquid crystal droplets within the data storage material of the device, a source of coherent light at a wavelength and power sufficient to cause zones of aligned directors of nematic liquid crystal droplets to fluoresce at a detectably greater intensity compared to zones of non-aligned directors within the data storage material and means for detecting fluorescence within the zones of aligned directors. As discussed above the sources of light used for both writing and reading data may constitute a pulsed laser used in conjunction with an objective lens to focus the illumination to particular zones of the data storage material. The writing illumination may also constitute continuous wave (CW) two-photon illumination, for example. Preferably the components of the apparatus will be computer operated to coordinate the laser illumination, shutter speed and focus of the illumination within the data storage material. Focus of illumination may for example be achieved by movement of the objective lens, or more preferably by provision of means within the apparatus for retaining and locating the device which can controllably move the device in two or preferably three dimensions. By movement of the device in a coordinated manner in relation to the illumination it is possible to select focal zones for illumination within the data storage material. In one embodiment the means for retaining and locating the device may allow the device to rotate and simultaneously to move up or down through the axis of incident illumination.

Preferably the apparatus also includes an ultraviolet light source which may be utilised to erase data stored on the data storage material. This may be via an unpolarised mercury light source, or by circularly polarised light, for example.

With reference to FIG. 4 there is shown one example of the optical equipment which may be utilised according to the present invention. The apparatus comprises a pulsed laser 1 which emits light through a mechanical shutter 2 which is under computer 16 control. The apparatus also comprises lenses 3 and 4 and a pinhole aperture 5 as well as quarter wave plate 6 and Glan-Thomson polariser 7, aperture 8, dichroic beam splitter 9, short pass filter 10, lens 11 and objective lens 12 as well as a PMT/CCD camera 15 for fluorescence detection, which is also under computer control. The data storage material 13 is mounted on a translation stage 14, which in one example of the invention constitutes a Mellers Griot nanomover micro positioning system, under computer control.

An important aspect of the present invention is that as opposed to simple storage of binary data where for example the logic states may be 1 and 0 it is possible, by variation of the polarisation state of the writing beam to have incremental fluorescence intensities from each illuminated zone of the data storage material during reading. This leads to the possibility of an increased number of logic states which in turn results in a dramatically increased data storage capacity of the data storage material. For example, 2,3,4,5,6 or even greater logic states for each illuminated zone may be achieved.

It is to be recognised that the present invention has been described by way of example only and that modifications and/or alterations which would be readily apparent to a person skilled in the art based upon the disclosure herein are also considered to fall within the scope and spirit of the invention.

The invention will now be further described, with reference to the following non-limiting examples:

### EXAMPLES

### Example 1

### PDLC Material Induced Two-Photon Polarisation Sensitivity

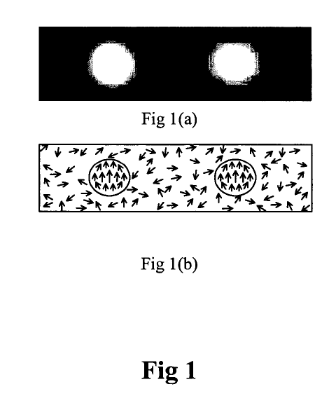

The image in FIG. 1(a) shows two bright dots which occur upon reading illumination of PDLC material comprising the components PMMA:E49:ECZ:TNF in a ratio of 45:33:21:1 by weight percentage. These bright dots are where the liquid crystal directors are aligned. The darker region was not illuminated with the writing light. This image shows the fluorescence when illuminated with a reading wavelength of 850 nm under two-photon (2-p) excitation. The image in FIG. 1(b) depicts this effect graphically.

### Example 2

### PDLC Material and Preparation

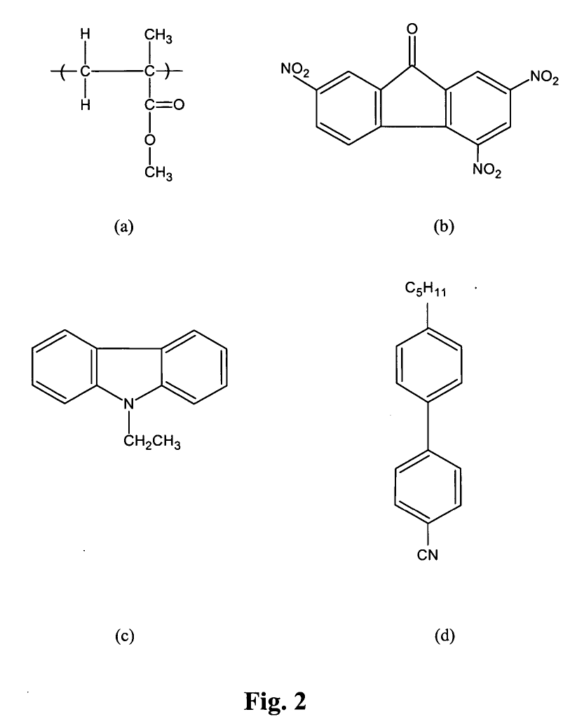

The complete PDLC material is a mixture of nematic liquid crystal droplets, photosensitive material, a plasticiser and a polymer backbone. Poly(methyl methacrylate) (PMMA) was used for the polymer matrix (FIG. 2(a)). PMMA is well proven for its physical and optical characteristics.

2,4,7-trinitro-9-fluorenone (TNF) is the photosensitive agent (FIG. 2(b)), which provides the absorption in the UV to visible region of the spectrum. N-ethylcarbazole (ECZ) was included as a plasticiser (FIG. 2(c)), which reduces the glass transition temperature of the polymer. The liquid crystals used were purchased from Merck Pty Ltd (product number E49), also known as 4-pentyl 4-cyano biphenyl (FIG. 2(d)). All three components were doped into PMMA. The concentrations of the components within the sample were PMMA:E49:ECZ:TNF, 45:33:21:1 wt %.

Phase separation methods were utilised to manufacture the PDLCs. The samples were prepared using two different methods of phase separation; these being polymerisation induced and solvent induced phase separation. Thermally induced phase separation may be used and also photopolymerisation of a prepolymer.

Polymerisation induced phase separation involved firstly the removal (via distillation) of inhibitor from the monomer. The monomer is then heated with agitation for 8 minutes (in a nitrogen environment) at 90° C. with 0.5% benzoyl peroxide and then cooled to room temperature. The plasticiser (ECZ), TNF and the E49 were then included into the syrup (ratio shown above) and stirred until a homogenous mixture was obtained. The resulting mixture was then poured into a Teflon vial and placed in the oven at 40° C. for 14 hours. This produced thick samples of PDLC material.

Solvent induced phase separation involved firstly the full polymerisation of the monomer (after the inhibitor was removed). The fully polymerised PMMA was dissolved in chloroform and gently heated at 40° C. in a Teflon vial. The ECZ, TNF and E49 were then added and stirred continuously. As the solvent evaporated, the mixture became viscous. The liquid was then poured onto a glass slide and allowed to cool to room temperature. With time, all of the solvent evaporates from the sample leaving a flat homogenous film of PDLC material. The rate of solvent evaporation affects liquid crystal droplet size with the droplet size increasing as the rate of solvent removal is decreased.

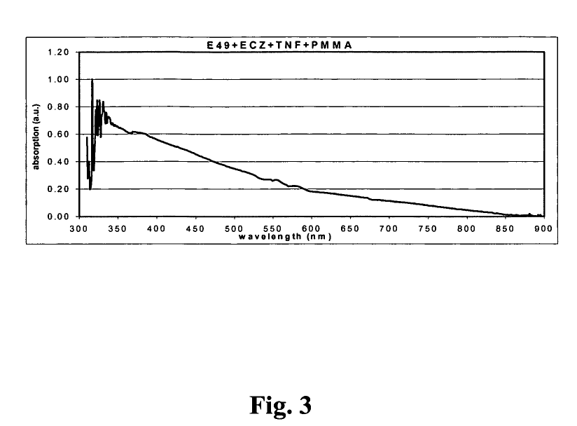

Both methods of phase separation cause the liquid crystals to form micro-droplets that set inside the polymer matrix. The samples in the following experiments were produced via the solvent induced phase separation method, which can be used to produce thin samples (90, 130 and 320 μm). No additional preparation was required to use these samples. The absorption spectrum of the sample produced by the solvent induced phase separation method is shown in FIG. 3, as recorded using a UV-VIS spectrophotometer using a Xenon arc lamp.

### Example 3

### Experimental Apparatus for Data Writing and Reading

As can be seen from the absorption spectrum, the absorption of this new material (prepared according to example 2) is negligible at a wavelength of 900 nm. Therefore, a laser with an infra-red wavelength at 900 nm can be used in the writing process to produce two-photon (2-p) excitation at 450 nm. A reading wavelength of 850 nm or 900nm, for example, can be used for 2-p fluorescence imaging.

An example of an optical system which may be used for 2-p excitation is represented in FIG. 4. A Spectra-Physics Tsunami (Ti-Sapphire) ultrashort pulsed laser is focused into the PDLC sample. This laser produces an ultrashort pulsed beam that has a pulse width of 80 fs and a repetition rate of 82 MHz.

A mechanical shutter and computer control the recording of the binary data bits. The sample is mounted on an x-y-z translation stage, which has 10 nm resolution and 100 nm repeatability. This 3-D translation stage was a Melles Griot nanomover micropositioning system. The objective used was an ULWD MSPlan 100-IR with a numerical aperture of 0.80 and the pinhole size was 50 μm.

The inherent sectioning properties of the 2-p process enables depth discrimination, therefore allowing data to be written and read inside the polymer. The polarisation state of the writing and reading beams are controlled with a quarter wave plate and Glan-Thomson polariser.

### Example 4

### Polarisation Dependence Studies

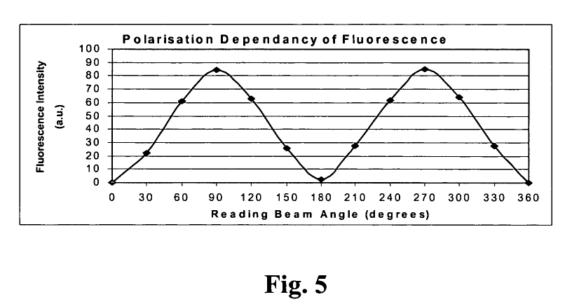

FIG. 5 indicates the dependence of the fluorescence intensity on the polarisation state of the reading beam. The off bit or non-written area does not have any polarisation dependence. That is, there is no variation in intensity as the polarisation state of the reading light is altered. The intensity of the fluorescence in the written zones changes quite considerably as the reading polarisation changes. This indicates that the fluorescence is greater at certain angles, with peaks 180 degrees apart.

According to FIG. 1, the directors of the liquid crystals align with the electric field of the focused writing beam. If the writing light source is polarised, at the focus spot an alignment of the liquid crystal directors can occur and this alignment will remain even when the illumination light is extinguished. If the reading beam illuminates this written region, fluorescence occurs efficiently when the polarisation direction of the reading beam is orthogonal to the aligned directors. FIG. 5 graphically demonstrates this polarisation sensitivity. Fluorescence in the written region efficiently occurs at specific polarisation angles ie. when the electric field is orthogonal to the aligned liquid crystal directors (90 and 270 degrees in FIG. 5). The other angles (0 and 180 degrees) show little fluorescence. This is because the electric field is parallel to the alignment within the written region.

### Example 5

### Fluorescence Saturation Studies

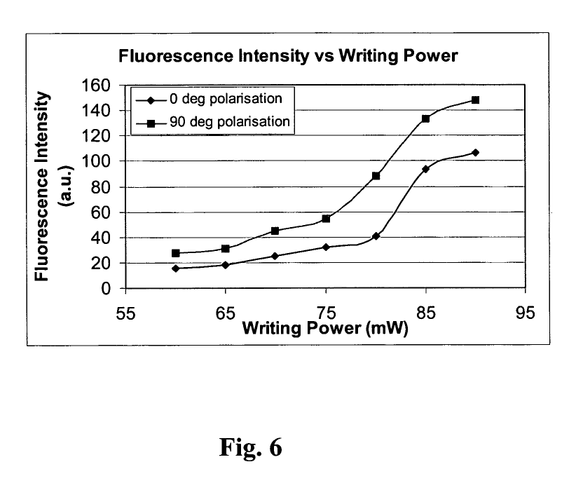

The plot shown in FIG. 6 demonstrates the fluorescence intensity of the aligned liquid crystal directors as a function of the writing power, under two circumstances. The first case is when the bits are read at 0° polarisation shift from the writing beam and the second case is when the reading illumination has undergone a 90° polarisation shift relative to the writing beam. Maximum fluorescence can be found when the reading beam is at 90° polarisation shift from the writing beam. This effect can be utilised for single bit erasure of the stored data. This effect may also be used for polarisation multiplexing or encoding additional data at the location of each stored data bit.

### Example 6

### Multilayer Recording Studies

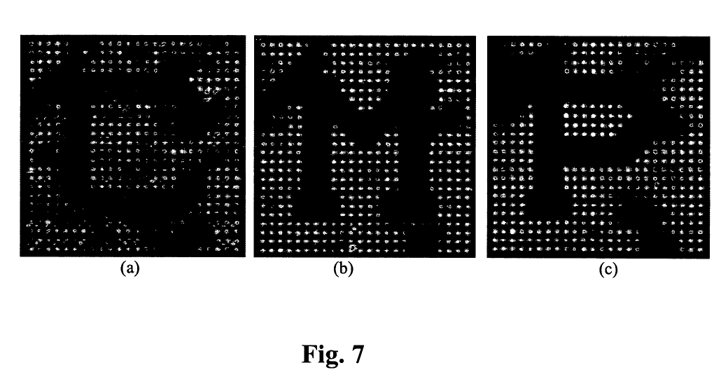

FIG. 7 shows three layers of data. The first layer shows the letter “C”. This letter is composed of a grid of 24×24 data bits. At a 2 μm depth into the polymer, the letter “M” was written and a further 2 μm deeper into the polymer the letter “P” was written. The point spacing in the x-y plane is 1.56 μm, with an axial resolution of 2 μm. This provides a data density of 204.8 Gbits/cm³. This is equivalent data density to a compact disc with 300 Gigabytes of data.

A number of techniques can be used to minimise the spot size therefore increasing the bit concentration in the x, y and z directions. The size of the data bit is directly related to the size of the focal spot of the recording objective, therefore techniques to reduce the aberration related to the refractive index mismatch will be explored. The exposure power and time also have a bearing on the size of the data bit.

Four layers with a 2.92 μm bits spacing and a 6 μm layer spacing have been successfully written into the polymer.

### Example 7

### Bulk Erasure of Stored Data

To erase bulk recorded information, the data block of interest was illuminated with uniform UV light from a mercury lamp. This uniform, unpolarised light redistributes the directors of the liquid crystals within the droplets and causes the data bits to be deleted.

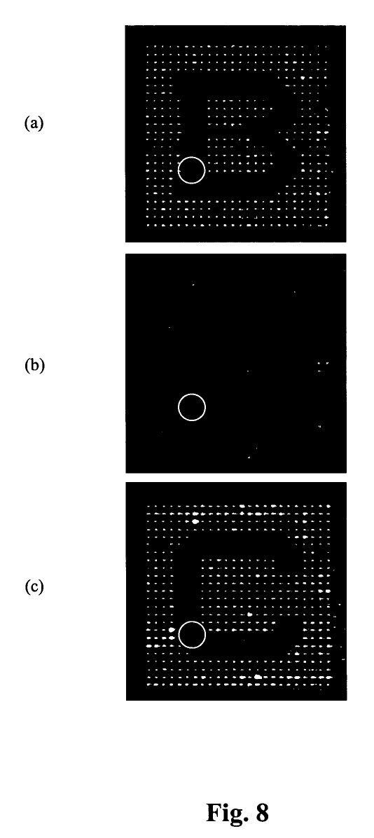

FIG. 8(a) represents a 24×24 block of data with point spacing of 2.9 μm. FIG. 8(b) is an image of the same area showing the location of the previously written data bits. Note the defects in the polymer (highlighted by the two white rings). These indicate that the images show the same position and depth. FIG. 8(c) shows the same layer of polymer material, but with the letter C written in place of the erased data bits of FIG. 8(b).

### Example 8

### Bit Erasure of Stored Data

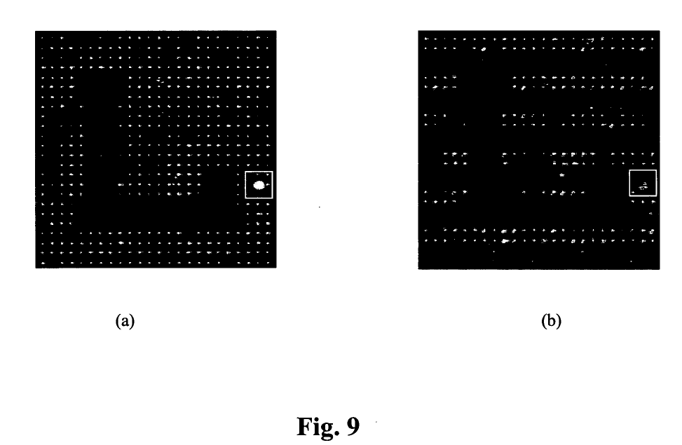

As shown in FIG. 5 above, there is dependence of the fluorescence of the aligned liquid crystals upon the polarisation state of the reading beam. This characteristic can be utilised to delete an individual bit of data, as shown in FIG. 9. To erase an individual data bit the writing beam can be rotated by 90° and the data bit can be overwritten. This re-aligns the directors of the liquid crystals and therefore produces a contrast between the highly fluorescent aligned directors and the redistributed directors of the erased bit.

In this example the letter “L” was written into the polymer material at a polarisation shift of 0°. The area of interest was then read at 90° showing the fluorescent data bits of the letter “L” as shown in FIG. 9(a). To erase the bit, the polarisation state of the beam was rotated by 90° relative to the original writing beam and overwritten at high power (60-80 mW). This reduces the relative fluorescence of the particular bit concerned when it is read again at 90° polarisation shift, under low power (30 mW), as shown in FIG. 9(b), where the rewritten data bit is highlighted by the square within FIGS. 9(a) and 9(b).

### Example 9

### Stability of Stored Data

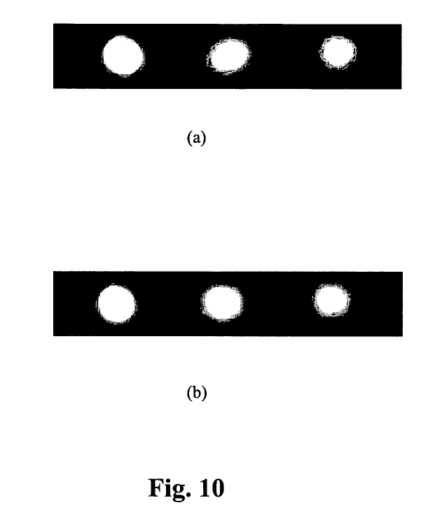

The data stored in the PDLCs shows little deterioration after being read constantly. The images below show three data bits. The first image (FIG. 10(a)) shows the dots after being read 300 times. The second image (FIG. 10(b)) shows very little deterioration even after another 500 read cycles.

As can be seen from the intensity profile, the signal to noise ratio is 43:1 which corresponds to a contrast of 0.91.

### Example 10

### Dependence of Fluorescence Intensity on Reading Wavelength

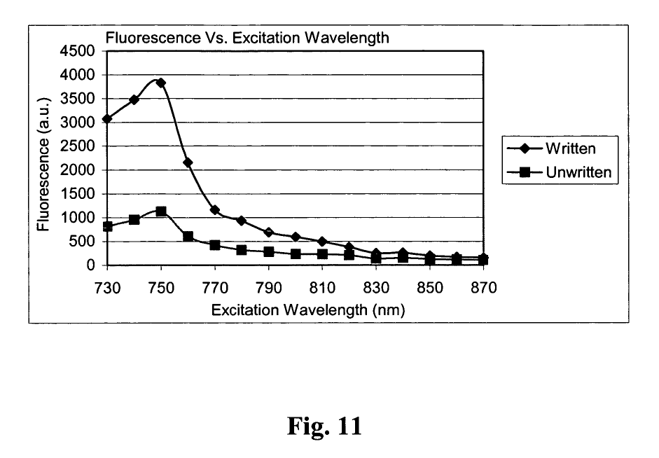

As the excitation wavelength in the reading process is varied, the fluorescence also varies. FIG. 11 shows the variation in fluorescence under various excitation wavelengths. The wavelengths illustrated are for 2-p fluorescence.

### Example 11

### Two-Photon Excitation and Multiplexing of Stored Data

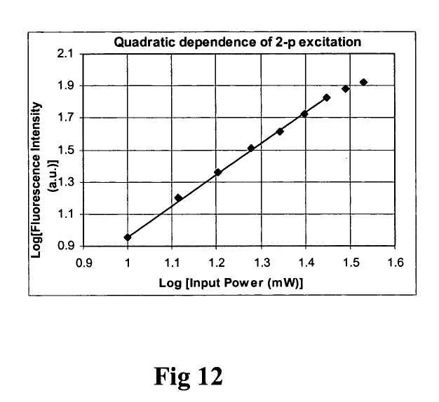

2-photon (2-p) excitation allows spatial confinement of the focal spot in all three dimensions. There is a quadratic dependence of the 2-p process on the laser intensity. As shown in FIG. 12 the plot has a slope of 1.98, which indicates that the process is indeed a 2-p excitation process. The drop off at the upper end of the plot reveals the onset of saturation.

Further work has been conducted to demonstrate the possibility of data multiplexing resulting from 2-p polarisation in PDLCs. Utilising the polarisation dependent properties of the data storage polymer material, the peak of the fluorescence can be shifted through 90° reading beam rotation. This shift can be configured to represent for example, 0, 1, 2, 3, 4, etc . . . data values. In this way, instead of storing a binary 0 or 1 data point, more values can be stored.

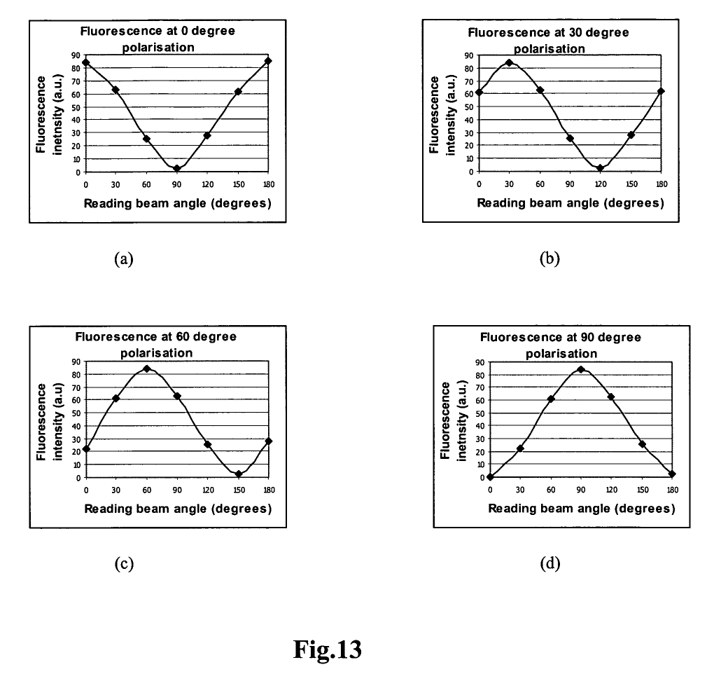

FIG. 13 shows the variation of fluorescence depending upon the initial alignment of the liquid crystal directors. In this case each data bit could have a value of 0, 1, 2 or 3 stored at that location. This is represented by the initial writing alignment of the directors of the liquid crystals. A fluorescence peak at 0 degrees represents a “0” , a fluorescence peak at 30 degrees represents a “1”, a fluorescence peak at 60 degrees represents a value of “2” and finally a fluorescence peak at 90 degrees represents a “3”.

### REFRENCES

1. Y. Kawata et al, Opt. Lett 23, 156 (1998).

2. P. M. Lundquist et al, Science 274, 1182 (1996).

3. A Toriumi et al, Opt Lett 22 555 (1997).

4. A Toriumi et al, Opt Lett 24, 1924 (1998).

5. D. Day et al., Opt Lett 24, 948 (1999).

6. K. Meerholz et al, Nature 371, 497 (1994).

7. A. Golemme, Opt Lett 22, 1226 (1997).

1. A three-dimensional optical data storage device comprising a data storage material which comprises the following components:
(a) a polymer matrix; and
(b) nematic liquid crystal droplets;
wherein component (b) is dispersed through the polymer matrix.

2. The three-dimensional optical data storage device according to claim 1, wherein the data storage material further comprises a photosensitive material dispersed through the polymer matrix.

3. The three-dimensional optical data storage device according to claim 1, wherein the data storage material further comprises a plasticiser dispersed through the polymer matrix.

4. The three-dimensional optical data storage device according to claim 1, wherein the polymer matrix comprises poly(methylmethacrylate), poly(vinylchloride) or poly(vinylcarbozole).

5. The three-dimensional optical data storage device according to claim 1, wherein the nematic liquid crystal droplets are selected from E 49, E 44 and E 7.

6. The three-dimensional optical data storage device according to claim 2, wherein the photosensitive material is selected from 2,4,7-trinitro-9-fluorenone and buckminsterfullerene.

7. The three-dimensional optical data storage device according to claim 3, wherein the plasticiser is selected from N-ethylcarbazole, iso-butyl formate and methyl isobutyrate.

8. The three-dimensional optical data storage device according to claim 1, further comprising an initiator.

9. The three-dimensional optical data storage device according to claim 8, wherein the initiator comprises benzoyl peroxide.

10. The three-dimensional optical data storage device according to claim 2, which comprises between about 10 to about 70 wt % of polymer matrix, between about 20 to about 90 wt % of nematic liquid crystal droplets and up to about 5 wt % of photosensitive material.

11. The three-dimensional optical data storage device according to claim 10, further comprising up to about 40 wt % of plasticiser and up to about 0.1 wt % of initiator.

12. The three-dimensional optical data storage device according to claim 1, further comprising a substrate, on or about which the data storage material is located.

13. The three-dimensional optical data storage device according to claim 12, wherein the data storage material is between about 10 μm and about 2,000 μm in thickness.

14. The three-dimensional optical data storage device according to claim 12, wherein the substrate protectively encloses the data storage material and at least a region of the substrate allows transmission of visible and infra-red radiation to and from the data storage material.

15. The three-dimensional optical data storage device according to claim 14, wherein at least a region of the substrate allows transmission of ultra-violet radiation to and from the data storage material.

16. A method of storing optical data comprising exposing zones of data storage material of a three-dimensional optical data storage device to coherent polarised light at a wavelength and power sufficient to cause alignment of directors of illuminated zones of nematic liquid crystal droplets within the data storage material; wherein the light encodes for the data to be stored, and wherein the data storage material comprises the following components:
(a) a polymer matrix; and
(b) nematic liquid crystal droplets;
wherein component (b) is dispersed through the polymer matrix.

17. The method according to claim 16, wherein the data storage material further comprises a photosensitive material dispersed through the polymer matrix.

18. The method according to claim 16, wherein the data storage material further comprises a plasticiser dispersed through the polymer matrix.

19. The method according to claim 16, wherein the polymer matrix comprises poly(methylmethacrylate), poly(vinylchloride) or poly(vinylcarbozole).

20. The method according to claim 16, wherein the nematic liquid crystal droplets are selected from E 49, E 44 and E 7.

21. The method according to claim 17, wherein the photosensitive material is selected from 2,4,7-trinitro-9-fluorenone and buckminsterfullerene.

22. The method according to claim 18, wherein the plasticiser is selected from N-ethylcarbazole, iso-butyl formate and methyl isobutyrate.

23. The method according to claim 16, wherein the data storage material further comprises an initiator.

24. The method according to claim 23, wherein the initiator comprises benzoyl peroxide.

25. The method according to claim 16, wherein the data storage material comprises between about 10 to about 70 wt % of polymer matrix, between about 20 to about 90 wt % of nematic liquid crystal droplets and up to about 5 wt % of photosensitive material.

26. The method according to claim 25, wherein the data storage material further comprises up to about 40 wt % of plasticiser and up to about 0.1 wt % of initiator.

27. The method according to claim 16, wherein the data storage device further comprises a substrate, on or about which the data storage material is located.

28. The method according to claim 27, wherein the substrate protectively encloses the data storage material and at least a region of the substrate allows transmission of ultraviolet, visible and infra-red radiation to and from the data storage material.

29. The method according to claim 16, wherein the light is at a wavelength of between about 500 nm and about 1000 nm.

30. The method according to claim 16, wherein the light is at a wavelength of between about 850 nm and 950 nm.

31. The method according to claim 16, wherein the light is at a wavelength of about 900 nm.

32. The method according to claim 16, wherein the power of the light is between about 30 mW and about 100 mW.

33. The method according to claim 16, wherein the power of the light is between about 40 mW and about 80 mW.

34. The method according to claim 16, wherein the power of the light is about 60 mW.

35. The method according to claim 16, wherein the light is provided by an ultrashort pulsed laser.

36. A method of reading optical data from a three-dimensional optical data storage device which comprises exposing data storage material of the device which has optical data stored therein to coherent polarised light at a wavelength and power sufficient to cause zones of aligned directors of nematic liquid crystal droplets within the data storage material to fluoresce at a detectably greater intensity compared to zones of non-aligned directors, and detecting fluorescence within the zones of aligned directors; wherein the data storage material comprises the following components:
(a) a polymer matrix; and
(b) nematic liquid crystal droplets;
wherein component (b) is dispersed through the polymer matrix.

37. The method according to claim 36, wherein the data storage material further comprises a photosensitive material dispersed through the polymer matrix.

38. The method according to claim 36, wherein the data storage material further comprises a plasticiser dispersed through the polymer matrix.

39. The method according to claim 36, wherein the polymer matrix comprises poly(methylmethacrylate), poly(vinylchloride) or poly(vinylcarbozole).

40. The method according to claim 36, wherein the nematic liquid crystal droplets are selected from E 49, E 44 and E 7.

41. The method according to claim 37, wherein the photosensitive material is selected from 2,4,7-trinitro-9-fluorenone and buckminsterfullerene.

42. The method according to claim 38, wherein the plasticiser is selected from N-ethylcarbazole, iso-butyl formate and methyl isobutyrate.

43. The method according to claim 36, wherein the data storage material further comprises an initiator.

44. The method according to claim 43, wherein the initiator comprises benzoyl peroxide.

45. The method according to claim 36, wherein the data storage material comprises between about 10 to about 70 wt % of polymer matrix, between about 20 to about 90 wt % of nematic liquid crystal droplets and up to about 5 wt % of photosensitive material.

46. The method according to claim 45, wherein the data storage device further comprises up to about 40 wt % of plasticiser and up to about 0.1 wt % of initiator.

47. The method according to claim 36, wherein the data storage device further comprises a substrate, on or about which the data storage material is located.

48. The method according to claim 47, wherein the substrate protectively encloses the data storage material and at least a region of the substrate allows transmission of ultraviolet, visible and infra-red radiation to and from the data storage material.

49. The method according to claim 36, wherein the light is at a wavelength of between about 500 nm and about 1000 nm.

50. The method according to claim 36, wherein the light is at a wavelength of between about 500 nm and 950 nm.

51. The method according to claim 36, wherein the light is at a wavelength of about 900 nm.

52. The method according to claim 36, wherein the power of the light is between about 10 mW and about 100 mW.

53. The method according to claim 36, wherein the power of the light is between about 20 mW and about 60 mW.

54. The method according to claim 36, wherein the power of the light is about 30 mW.

55. The method according to claim 36, wherein the light is provided by an ultrashort pulsed laser.

56. The method according to claim 36 wherein said fluorescence is detected using a photomultiplier tube, a CCD camera, a photodiode or a split photodiode detector.

57. A method of erasing bulk optical data stored on a three-dimensional optical data storage device which comprises exposing data storage material of the device to incoherent unpolarised ultra-violet light; wherein the data storage material comprises the following components:
(a) a polymer matrix; and
(b) nematic liquid crystal droplets;
wherein component (b) is dispersed through the polymer matrix.

58. The method according to claim 57, wherein the data storage material further comprises a photosensitive material dispersed through the polymer matrix.

59. The method according to claim 57, wherein the data storage material further comprises a plasticiser dispersed through the polymer matrix.

60. The method according to claim 57, wherein the polymer matrix comprises poly(methylmethacrylate), poly(vinylchloride) or poly(vinylcarbozole).

61. The method according to claim 57, wherein the nematic liquid crystal droplets are selected from E 49, E 44 and E 7.

62. The method according to claim 58, wherein the photosensitive material is selected from 2,4,7-trinitro-9-fluorenone and buckminsterfullerene.

63. The method according to claim 59, wherein the plasticiser is selected from N-ethylcarbazole, iso-butyl formate and methyl isobutyrate.

64. The method according to claim 57, wherein the data storage material further comprises an initiator.

65. The method according to claim 64 wherein the initiator comprises benzoyl peroxide.

66. The method according to claim 57, wherein the data storage material comprises between about 10 to about 70 wt % of polymer matrix, between about 20 to about 90 wt % of nematic liquid crystal droplets and up to about 5 wt % of photosensitive material.

67. The method according to claim 66, wherein the data storage material further comprises up to about 40 wt % of plasticiser and up to about 0.1 wt % of initiator.

68. The method according to claim 57, wherein the data storage device further comprises a substrate, on or about which the data storage material is located.

69. The method according to claim 68, wherein the substrate protectively encloses the data storage material and at least a region of the substrate allows transmission of infra-red radiation to and from the data storage material.

70. The method according to claim 57, wherein the ultraviolet light is generated by a mercury lamp.

71. A method for erasing bit optical data stored on a three-dimensional optical data storage device and for overwriting with new data which comprises exposing a zone where the bit data is stored within the data storage material to coherent polarised light rotated by between about 300 to about 150° relative to direction of coherent polarised light used to store the data, which rotated light is at a wavelength and power sufficient to realign directors of illuminated zones of nematic liquid crystal droplets in illuminated zone within the data storage material; wherein the rotated light erases the data that was previously written, and wherein the data storage material comprises the following components:
(c) polymer matrix; and
(d) nematic liquid crystal droplets;
wherein component (b) is dispersed through the polymer matrix.

72. The method according to claim 71, wherein the data storage material further comprises a photosensitive material dispersed through the polymer matrix.

73. The method according to claim 71 wherein the data storage material further comprises a plasticiser dispersed through the polymer matrix.

74. The method according to claim 71, wherein the polymer matrix comprises poly(methylmethacrylate), poly(vinylchloride) or poly(vinylcarbozole).

75. The method according to claim 71, wherein the nematic liquid crystal droplets are selected from E 49, E 44 and E 7.

76. The method according to claim 72, wherein the photosensitive material is selected from 2,4,7-trinitro-9-fluorenone and buckminsterfullerene.

77. The method according to claim 73, wherein the plasticiser is selected from N-ethylcarbazole, iso-butyl formate and methyl isobutyrate.

78. The method according to claim 71, wherein the data storage material further comprises an initiator.

79. The method according to claim 78, wherein the initiator comprises benzoyl peroxide.

80. The method according to claim 71, wherein the data storage material comprises between about 10 to about 70 wt % of polymer matrix, between about 20 to about 90 wt % of nematic liquid crystal droplets and up to about 5 wt % of photosensitive material.

81. The method according to claim 80, wherein the data storage device further comprises up to about 40 wt % of plasticiser and up to about 0.1 wt % of initiator.

82. The method according to claim 71, wherein the data storage device further comprises a substrate, on or about which the data storage material is located.

83. The method according to claim 82, wherein the substrate protectively encloses the data storage material and at least a region of the substrate allows transmission of ultraviolet, visible and infra-red radiation to and from the data storage material.

84. The method according to claim 71, wherein the light is at a wavelength of between about 800 nm and about 1000 nm.

85. The method according to claim 71, wherein the light is at a wavelength of between about 850 nm and 950 nm.

86. The method according to claim 71, wherein the light is at a wavelength of about 900 nm.

87. The method according to claim 71, wherein the power of the light is between about 10 mW and about 100 mW.

88. The method according to claim 71, wherein the power of the light is between about 20 mW and about 60 mW.

89. The method according to claim 71, wherein the power of the light is about 30 mW.

90. The method according to claim 71, wherein the light is provided by an ultrashort pulsed laser.

91. Apparatus for storing optical data to, and reading optical data from, a data storage device, which apparatus comprises:
(i) means for retaining and locating the device;
(ii) a source of coherent polarised light at a wavelength and power sufficient to cause alignment of directors of illuminated zones of nematic liquid crystal droplets within data storage material of the device;
(iii) a source of coherent polarised light at a wavelength and power sufficient to cause zones of aligned directors of nematic liquid crystal droplets to fluoresce at a detectably greater intensity compared to zones of non-aligned directors within the data storage material;
(iv) means for detecting fluorescence within the zones of aligned directors.

92. Apparatus according to claim 91 further comprising a source of incoherent unpolarised UV light.

93. The apparatus according to claim 91 wherein the means for retaining and locating the device is adapted to controllably move the device in three dimensions.

94. The apparatus according to claim 91 wherein the light is provided by an ultrashort pulsed laser.

95. The apparatus according to claim 91 wherein said means for detecting fluorescence is a photomultiplier tube, a CCD camera, a photodiode or a split photodiode detector.

96. The apparatus according to claim 92 wherein the source of incoherent unpolarised UV light is a mercury lamp.
